(19) United States
(12) Patent Application Publication
(10) Pub. No.: US 2023/0125358 A1
(43) Pub. Date: Apr. 27, 2023

(54) QUARTER-WAVELENGTH ANTENNAS

(71) Applicant: HEWLETT-PACKARD DEVELOPMENT COMPANY, L.P., Spring, TX (US)

(72) Inventors: Ju-Hung Chen, Taipei City (TW); Po-Chao Chen, Taipei City (TW); Hung-Wen Cheng, Taipei City (TW)

(21) Appl. No.: 17/511,444

(22) Filed: Oct. 26, 2021

(51) Int. Cl. H01Q 9/04; H01Q 1/24

(52) U.S. Cl. CPC H01Q 9/0442; H01Q 1/243; H01Q 9/0421

(57) ABSTRACT

Examples of devices having a quarter-wavelength antenna are described herein. In an example, a device may include a chassis and a quarter-wavelength antenna. The quarter-wavelength antenna includes a resonant path electrically connected the chassis.

### BACKGROUND

An antenna, such as a quarter-wavelength antenna may be disposed inside an electronic device such as a laptop or a mobile phone for transmitting and receiving signals.

### BRIEF DESCRIPTION OF FIGURES

The detailed description is provided with reference to the accompanying figures, wherein:

FIG. 1 illustrates a device having a chassis and a quarter-wavelength antenna, according to an example;

FIG. 2 illustrates a device having a chassis, an antenna window, and a quarter-wavelength antenna, according to an example;

FIG. 3 illustrates a device having a chassis, an antenna window, a resonant path of a quarter-wavelength antenna, and an antenna feed line of the quarter wavelength antenna, according to an example;

FIG. 4 illustrates a device having an antenna feed line capacitively coupled to a resonant path of a quarter-wavelength antenna, according to an example; and

FIG. 5 illustrates a device having an antenna feed line directly coupled to a resonant path of a quarter-wavelength antenna, according to an example.

### DETAILED DESCRIPTION

For transmitting and receiving signals, electronic devices, such as laptops, mobile phones, or tablet computers include an antenna, for example, a Wi-Fi antenna or a 5G antenna Such an antenna is housed inside an antenna window of the electronic device. The antenna window is a slot created in a housing or a chassis of the electronic device to accommodate components of the antenna. The antenna has a resonant portion having a width of a quarter of a wavelength (λ) of the antenna, and a shorting portion coupled at one end of the resonant portion. Another end of the resonant path is open, i.e., a free-end. When the antenna is housed inside the antenna window, the resonant portion occupies λ/4 width within the antenna window. Also, the shorting portion of the antenna and the open end of the resonant portion are at gaps from the boundary of the antenna window. The gaps are for an optimum performance of the antenna. Due to such gaps and λ/4 width of the resonant portion within the antenna window, the antenna window is of a size that may restrict the availability of space for other electronic components within the electronic device.

The present subject matter describes example devices, such as laptops or mobile phones, in which antennas are accommodated within a relatively smaller internal space.

In accordance with the present subject matter, a device includes a chassis and a quarter-wavelength antenna. The chassis may refer to a conductive frame of the device on which electronic components, such as quarter-wavelength antennas, sensors, image capturing units, processing units, etc., of the device are disposed. The quarter-wavelength antenna resonates, i.e., transmits and receives signals, at about a quarter of a wavelength (λ) of the quarter-wavelength antenna. The wavelength (λ) herein may be referred to as a free-space wavelength of the quarter-wavelength antenna. The quarter-wavelength antenna may include 5G antenna, Wi-Fi antenna, etc.

In an example, the quarter-wavelength antenna is formed by a portion of the chassis of the device and a resonant path electrically connected the portion of the chassis. The portion of the chassis has a first width, and the resonant path has a second width. The portion of the chassis and the resonant path of the device are electrically connected such that a sum total of the first width and the second width is λ/4. The first width and the second width may vary with respect to each other depending on the type of the quarter-wavelength antenna and the position of the quarter-wavelength antenna inside the device,

The electrical integration of the portion of the chassis and the resonant path of the quarter-wavelength antenna allows for the portion of the chassis to operate as an active component of the quarter-wavelength antenna, whereby the width of the resonant path is reduced to less than λ/4. The reduction in the width of the resonant path to less than λ/4 facilitates in freeing up some internal space in the device. The freed-up space in the device can be used for accommodating an additional quarter-wavelength antenna or other electronic components, such as sensors, image capturing units, etc. As the portion of the chassis operates as an active component of the quarter-wavelength antenna, the quarter-wavelength antenna with of the resonant path of a reduced width delivers performance similar to that delivered by an antenna having a resonant path of a width of λ/4.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

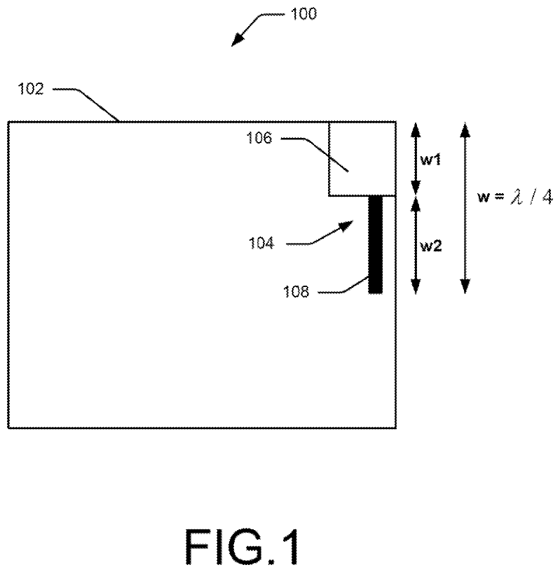

The manner in which the devices are implemented are explained in detail with respect to FIGS. 1-5. While aspects of described devices can be implemented in any number of different electronic devices and/or implementations, the examples are described in the context of the following system(s). It is to be noted that drawings of the present subject matter shown here are for illustrative purposes and are not drawn to scale.

FIG. 1 illustrates a device 100 having a chassis 102 and a quarter-wavelength antenna 104, according to an example. Examples of the device 100 may include, but are not limited to, a laptop, a notebook computer, a tablet computer, a smart phone, a smart watch, a modem, and a desktop computer. The chassis 102 is a conductive frame on which components, such as a motherboard, a storage unit, a camera, an antenna, etc. are mounted. In an example, the chassis 102 may be one of a display housing panel, a back cover, and a keyboard housing panel of the device 100. The quarter-wavelength antenna 104 is housed within the device 100 and resonates at about a quarter of a wavelength (λ) of the quarter-wavelength antenna 104.

The quarter-wavelength antenna 104 includes a portion 106 of the chassis 102. The portion 106 of the chassis 102 has a first width w1 and functions as a shorting portion of the quarter-wavelength antenna 104. In an example, the first width w1 is in a range of λ/40 to λ/8. In an example, the first width w1 is in a range of λ/16 to λ/8. In an example, the first width w1 is λ/8. Dimension of the first width w1 is dependent on the type of the quarter-wavelength antenna 104 used in the device 103.

The quarter-wavelength antenna 104 further includes a resonant path 108 having a second width w2. The resonant path 108 is made of a conductive material, such as a metal, to resonate the quarter-wavelength antenna 104 for transmitting and receiving electrical signals to/from another device (not shown). In an example, the second width w2 is in a range of λ/8 to 9λ/40. In an example, the second width w2 is in a range of λ/8 to 3λ/16. In an example, the second width w2 is λ/8. Dimension of the second width w2 is dependent on the type of the quarter-wavelength antenna 104 used in the device 100 and the size of the portion 106 of the chassis 102 available for use as a part of the quarter-wavelength antenna 104.

The resonant path 108 is electrically connected to the portion 106 of the chassis 102. The electrical connection ensures that the portion 106 of the chassis 102 and the resonant path 108 integrally function as the quarter-wavelength antenna 104.

The resonant path 108 is electrically connected to the portion 106 of the chassis 102 such that a sum total of the first width w1 and the second width w2 is about λ/4. The selection of the dimensions of the first width w1 and the second width w2 is flexible to make the sum total of the widths substantially equal to λ/4. In an example, the first width w1 is from λ/40 to λ/8 and the second width w2 is from λ/8 to 9λ/40. In an example, the first width w1 is from λ/16 to λ/8 and the second width w2 is from λ/8 to 3λ/16. In an example, the first width w1 is from 5λ/16 to λ/8 and the second width w2 is from λ/8 to 3λ/16. In an example, the first width w1 is λ/8 and the second width w2 is λ/8.

Since the portion 106 of the chassis 102 is used an integral part of the quarter-wavelength antenna 104, the resonant path 108 occupies less than λ/4 width in the device 100, which results in saving of the internal space in the device 100. The saved internal space may be used for placing other electronic components within the device 100 to enhance the applicability of the device 100. For example, in case the device 100 is a smart phone, an additional camera may be disposed in the saved internal space so as to enhance image capturing capabilities of the device 100.

In an example, the first width w1 and the second width w2 may vary with respect to each other depending on the type of the quarter-wavelength antenna 104 and the position of the quarter-wavelength antenna 104 inside the device 100. For example, in case the quarter-wavelength antenna 104 is a 5G antenna and the device 100 is a laptop, the 5G antenna may be disposed at a corner of a display housing cover of the laptop such that a portion of a chassis of the laptop at the corner is electrically connected with a resonant path of the 5G antenna. In such a case, the width of the portion of the chassis may be λ/16 and the width of the resonant path may therefore be 3λ/16.

In an example, the quarter-wavelength antenna 104 includes a frequency tuning circuit (not shown in FIG. 1). The frequency tuning circuit enables impedance matching which improved the power transfer capability of the quarter-wavelength antenna 104. The frequency tuning circuit may be regulated such that the power transfer by the quarter-wavelength antenna 104 is unaffected irrespective of dimensions of the first width w1 and the second width w2. In an example, the frequency tuning circuit may be one of an impendence matching circuit and a lumped element.

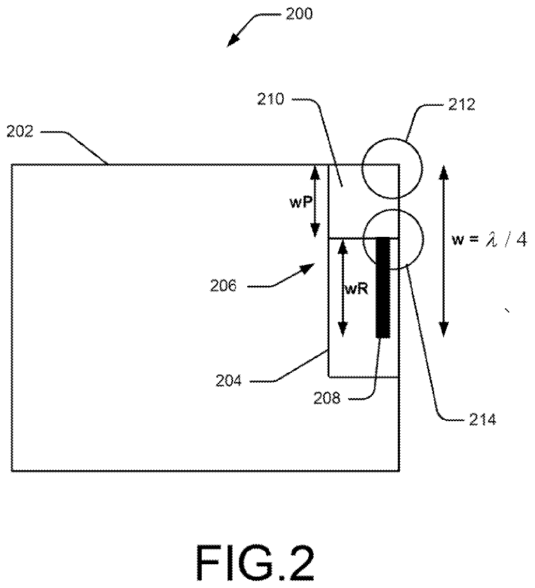

FIG. 2 illustrates a device 200 having a chassis 202, an antenna window 204, and a quarter-wavelength antenna 206, according to an example. In an example, the device 200 may be similar to the device 100 of FIG. 1. In an example, the chassis 202 may be one of a display housing panel, a back cover, and a keyboard housing panel of the device 200. The display housing panel houses a display panel (not shown), such as a light emitting diode (LED) based display panel. The back cover may be a base cover of the device 200. The keyboard housing panel of the device 200 houses a keyboard of the device 200.

In the device 200, the antenna window 204 is disposed in the chassis 202. The antenna window 204 may refer to a window that can accommodate components of an antenna. In an example, the antenna window 204 may be fabricated by etching the surface of the chassis 202. Further, the quarter-wavelength antenna 206, which is similar to the quarter-wavelength antenna 104 of FIG. 1, has a width w equal to λ/4.

The quarter-wavelength antenna 206 includes a resonant path 208 disposed in the antenna window 204. The resonant path 208 is similar to the resonant path 108 of FIG. 1 and has a width wR in a range of λ/8 to 9λ/40.

The quarter-wavelength antenna 206 further includes a portion 210 of the chassis 202. The portion 210 of the chassis 202 is electrically connected with the resonant path 208 so that the portion 210 of the chassis 202 operates as a part of the quarter-wavelength antenna 206. The portion 210 of the chassis 202 has a width wP in a range of λ/40 to λ/8.

The portion 210 of the chassis 202 electrically connected with the resonant path 208 is at a corner region 212 of the chassis 202. The corner region 212 of the chassis 202 is a region in close proximity to a vertex where two edge walls of the chassis 202 meet. The corner region 212 of the chassis 202 is shown by a circle in FIG. 2. Although, the portion 210 of the chassis 202 electrically connected with the resonant path 208 depicted in FIG. 2 is at the corner region 212 of the chassis 202, the portion of the chassis 202 can be at a location other than the corner region of the chassis 202, where the portion can be electrically connected with the resonant path to function as a part of the quarter-wavelength antenna.

Further, the portion 210 of the chassis 202 is electrically connected with the resonant path 208 at a region 214 of the chassis 202 adjacent to the antenna window 204. The region 214 of the chassis 202 adjacent to the antenna window 204 is shown by a circle in FIG. 2. The region 214 of the chassis 202 may refer to a region in dose proximity to a boundary at a corner of the antenna window 204 The corner of the antenna window 204 may refer to a vertex where edge walls of the antenna window 204 meet.

The electrical connection of the portion 210 of the chassis 202 and the resonant path 208 facilitates in reducing the width wR of the resonant path 208 to less than λ/4. Therefore, the antenna window 204 etched in the chassis 202 is of a smaller size in comparison to an antenna window otherwise etched for accommodating a resonant path of λ/4 width. The smaller antenna window 204 allows for freeing up some internal space in the device 200, which can be utilized for accommodating other electronic components, such as sensors, image capturing units, etc. In an example, when the width wR of the resonant path 208 is λ/8, the maximum internal space is freed-up in the device 200.

In an example, the portion 210 of the chassis 202, which is electrically connected to the resonant path 208, is at an edge region of the chassis 202. The edge region of the chassis 202 is at a boundary of the chassis 202.

In an example, the quarter-wavelength antenna 206 includes a frequency tuning circuit (not shown), similar to the frequency tuning circuit as described with reference to the device 100.

Although, the device 200 is depicted with one quarter-wavelength antenna 206, multiple quarter-wavelength antennas can be mounted inside the device 200. In an example, the device 200 may include a plurality of antenna windows 204 to accommodate the resonant paths of multiple quarter-wavelength antennas.

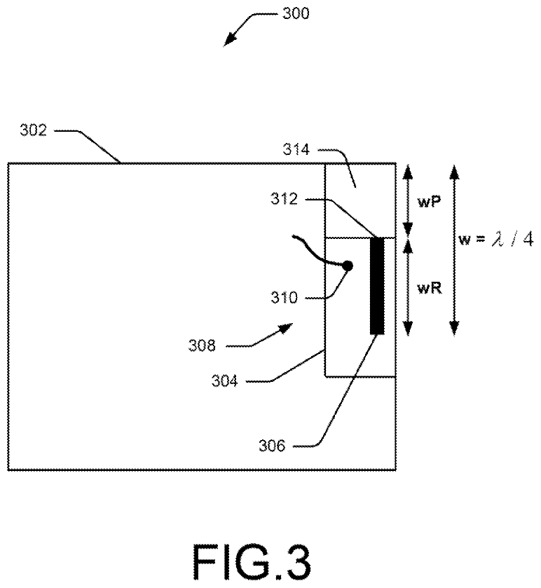

FIG. 3 illustrates a device 300 having a chassis 302, an antenna window 304 in the chassis 302, a resonant path 306 of a quarter-wavelength antenna 308, and an antenna feed line 310, according to an example. The device 300 may be similar to the device 100 and the device 200 of FIG. 1 and FIG. 2, respectively. The chassis 302 may be similar to the chassis 102 and the chassis 202 of FIG. 1 and FIG. 2, respectively. The antenna window 304 may be similar to the antenna window 204 of FIG. 2. Further, the resonant path 306 may be similar to the resonant path 108 and the resonant path 208 of FIG. 1 and FIG. 2, respectively. The resonant path 306 has a width wR from ⅛ of a wavelength (λ) of the quarter-wavelength antenna 308 to 9λ/40. The quarter-wavelength antenna 308 may be similar to the quarter-wavelength antenna 104 and the quarter-wavelength antenna 206 of FIG. 1 and FIG. 2, respectively. Further, the antenna feed line 310 of the device 300 is to supply power to the quarter-wavelength antenna 308 and to connect the quarter-wavelength antenna 308 with a transmitter (not shown) or a receiver (not shown).

In the device 300, the resonant path 306 of the quarter wavelength antenna 308 is disposed in the antenna window 304 in a similar manner as the resonant path 208 of FIG. 2 is disposed in the antenna window 204. The resonant path 306 is electrically connected to the chassis 302 and is interfacing the chassis 302 at a boundary 312 of the antenna window 304. The boundary 312 of the antenna window 304 may refer to as an edge wall of the antenna window 304. In an example, the boundary 312 of the antenna window 304 is at a region of the chassis 302 adjacent to the antenna window 304. In an example, the boundary 312 of the antenna window 304 can be any boundary of the antenna window 304. In an example, the region of the chassis 302 adjacent to the antenna window 304 is similar to the region 214 of the chassis 202 as shown in FIG. 2.

Further, a portion 314 of the chassis 302 adjacent to the boundary 312 of the antenna window 304 operates as a part of the quarter-wavelength antenna 308. In an example, the portion 314 of the chassis 302 operates as a shorting portion of the quarter-wavelength antenna 308. In an example, the portion 314 of the chassis 302 may operates both as a shorting portion of the quarter-wavelength antenna 308 and another resonant path additional to the resonant path 306. The portion 314 of the chassis 302 has a width wP from λ/40 to λ/8. In an example, any value of the width wR between λ/8 to 9λ/40 and the width wP between λ/40 to λ/8 can be selected that make the sum total width w of the width wR and the width wP of λ/4. In an example, the portion 314 of the chassis 302 operating as the shorting portion of the quarter-wavelength antenna 308 may be at a corner region of the chassis 302 similar to the corner region 212 of the chassis 202 shown in FIG. 2.

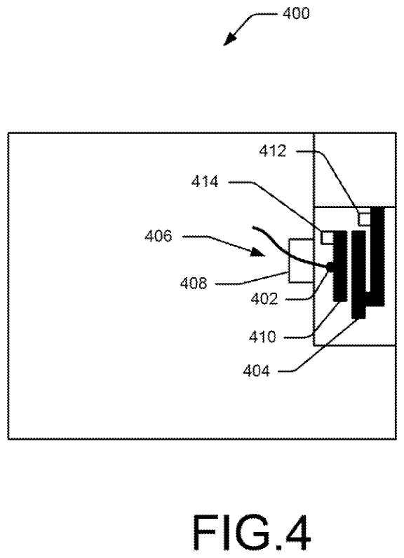

FIG. 4 illustrates a device 400 having an antenna feed line 402 capacitively coupled to a resonant path 404 of a quarter-wavelength antenna 406, according to an example. The device 400 may be similar to the device 300 of FIG. 3. The resonant path 404 may be similar to the resonant path 306. In an example, the device 400 includes a ground conductor 408 and a capacitive feed element 410 electrically connected to the ground conductor 408 and to the antenna feed line 402 of the device 400. The capacitive feed element 410 is at a distance from the resonant path 404. The ground conductor 408 is an electrically conductive surface, to which the quarter-wavelength antenna 406 is coupled. The capacitive feed element 410 is to deliver power signals to the resonant path 404 capacitively.

Further, the device 400 includes a first frequency tuning circuit 412 coupled to the resonant path 404 and a second frequency tuning circuit 414 coupled to the antenna feed line 402. In an example, the second frequency tuning circuit 414 is coupled to the antenna feed line 402 via the capacitive feed element 410. The first frequency tuning circuit 412 and the second frequency tuning circuit 414 are similar to the frequency tuning circuit as described with respect to the device 100.

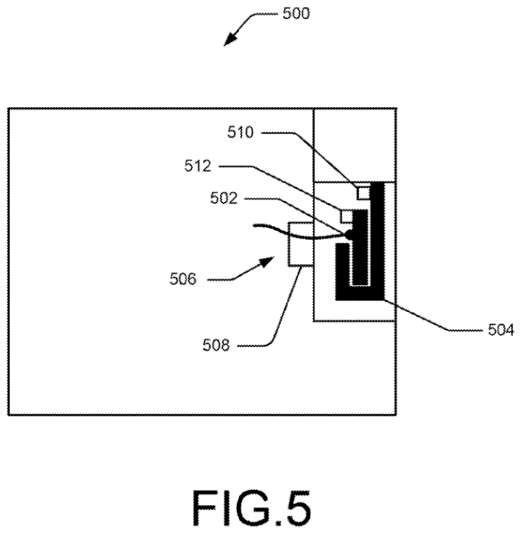

FIG. 5 illustrates a device 500 having an antenna feed line 502 directly coupled to a resonant path 504 of a quarter-wavelength antenna 506, according to an example. The device 500 may be similar to the device 300 of FIG. 3. In an example, the device 500 includes a ground conductor 508 similar to the ground conductor 408 of FIG. 4, to which the antenna feed line 502 is electrically coupled, which is further connected with the resonant path 504. The direct coupling of the resonant path 504 of the quarter-wavelength antenna 506 with the ground conductor 508 is to deliver power signals to the resonant path 504 directly. In an example, the antenna feed line 502 may be a coaxial cable.

Further, the device 500 includes a first frequency tuning circuit 510 coupled to the resonant path 504 and a second frequency tuning circuit 512 coupled to the antenna feed line 502. The first frequency tuning circuit 510 and the second frequency tuning circuit 512 are similar to the frequency tuning circuit as described with respect to the device 100.

Although aspects for the present disclosure have been described in a language specific to structural features and/or methods, it is to be understood that the appended claims are not limited to the specific features or methods described herein. Rather, the specific features and methods are disclosed as examples of the present disclosure.

We claim:

1. A device comprising:
a chassis; and
a quarter-wavelength antenna comprising:
a portion of the chassis, the portion being of a first width; and
a resonant path electrically connected the portion of the chassis, the resonant path being of a second width, a sum total of the first width and the second width being about a quarter of a wavelength (λ) of the quarter-wavelength antenna.

2. The device as claimed in claim 1, wherein the first width is from λ/40 to λ/8.

3. The device as claimed in claim 1, wherein the second width is from λ/8 to 9λ/40.

4. The device as claimed in claim 1, wherein the first width is λ/8 and the second width is λ/8.

5. The device as claimed in claim 1, wherein the quarter-wavelength antenna comprises a frequency tuning circuit

6. A device comprising:
a chassis;
an antenna window in the chassis; and
a quarter-wavelength antenna comprising:
a portion of the chassis of a width from 1/40 of a wavelength (λ) of the quarter-wavelength antenna to λ/8; and
a resonant path of a width from λ/8 to 9Aλ40, the resonant path being disposed in the antenna window and being electrically connected with the portion of the chassis at a region of the chassis adjacent to the antenna window.

7. The device as claimed in claim 6, wherein the portion of the chassis, electrically connected to the resonant path, is at a corner region of the chassis.

8. The device as claimed in claim 6, wherein the width of the resonant path is λ/8 and the width of the portion of the chassis is λ/8.

9. The device as claimed in claim 6, wherein the chassis is one of a display housing panel, a back cover, and a keyboard housing panel of the device.

10. The device as claimed in claim 6, wherein the quarter-wavelength antenna comprises a frequency tuning circuit

11. A device comprising:
a chassis;
an antenna window in the chassis;
a resonant path of a quarter-wavelength antenna disposed in the antenna window; and
an antenna feed line coupled to the resonant path,
the resonant path being electrically connected to the chassis and interfacing the chassis at a boundary of the antenna window; and
the resonant path being of a width from ⅛ of a wavelength (A) of the quarter-wavelength antenna to 9λ/40, and
a portion of the chassis of a width from λ/40 to λ/8 adjacent to the boundary of the antenna window being to operate as a part of the quarter-wavelength antenna.

12. The device as claimed in claim 11, wherein the boundary of the antenna window is at a region of the chassis adjacent to the antenna window.

13. The device as claimed in claim 11, wherein the antenna feed line is capacitively coupled to the resonant path.

14. The device as claimed in claim 11, wherein the antenna feed line is directly coupled to the resonant path.

15. The device as claimed in claim 11, wherein the device comprises:
a first frequency tuning circuit coupled to the resonant path; and
a second frequency tuning circuit coupled to the antenna feed line.
